(19) United States
(12) Patent Application Publication
(10) Pub. No.: US 2014/0220249 A1
(43) Pub. Date: Aug. 7, 2014

(54) INTERLACED PAINTING

(71) Applicant: ABB TECHNOLOGY AG, Zurich (CH)

(72) Inventor: Didier Rouaud, Bloomfield Hills, MI (US)

(73) Assignee: ABB Technology AG, Zurich (CH)

(21) Appl. No.: 13/761,339

(22) Filed: Feb. 7, 2013

(51) Int. Cl. B05B 15/12; B05D 1/02

(52) U.S. Cl. CPC B05B 15/1207; B05D 1/02; Y10S 901/02; Y10S 901/43
USPC 427/256; 118/697; 901/2; 901/43

(57) ABSTRACT

A system and method of applying coating to automotive workpieces is disclosed. A first coating dispensing robot dispenses coating at least a portion of an engine compartment, trunk and internal surfaces of a bed of an automotive workpiece during a first time interval, while a second robot dispenses coating on the exterior surface of fenders and passenger doors of the workpiece over the first time interval. The first robot dispenses coating on the exterior surface of a hood, roof, trunk lid and lift gate over a second time interval and the second robot dispenses coating on the side door interiors over the second time interval.

### FIELD OF INVENTION

The present disclosure concerns systems and methods for automatic spray coating of workpieces, and in particular robotically applied sprayed coatings of automotive workpieces such as partially assembled automobiles.

### BACKGROUND

Sprayed coatings applied to partially assembled automobiles during manufacturing can include primer coats, base coats and clear coats. Such coats can be applied with different coating dispensers, such as various known types of air-powered sprayers. Different types of paint or coating dispensers can be implemented during the manufacturing process of a particular workpiece. For example, an air-powered spray gun can be used on interior surfaces of a workpiece such as the internal surfaces of trunks and engine compartments and the portions of car doors, engine hoods and trunk lids that interface with the car frame. Such surfaces can have more intricate shapes and can be more difficult to access with a sprayer than, for example, the exterior surface of the finished automobile. Coverage of these surfaces typically requires air-powered spray guns, which are able to achieve good coverage. However, air-powered spray guns result in greater coating consumption per unit area covered and also higher levels of coating overspray than other forms of sprayers. Excessive overspray from conventional air-powered sprayers can therefore require greater movement of temperature-regulated air through the booth to evacuate the over-sprayed coating present in the booth.

In contrast with the intricate shapes found on such internal surfaces, exterior surfaces such as the external surfaces of the passenger doors, car hood and trunk lid are commonly easier to access by sprayers. As such exterior surfaces can be satisfactorily coated with more efficient dispenser types, such as more efficient atomizers, which consume less coating per unit area on which coating is applied and have significantly less overspray than conventional air-powered sprayers.

In coating processes utilizing different coating dispensers, the finish characteristics, the amount of overspray and the amount of air consumption required during the coating process will differ depending on the type of dispenser used. Under certain circumstances, utilizing different dispenser types requires having separate spray areas, whether these areas are separated by sufficient distance on an assembly line or involve separate booths segregated by curtains or doors. Whichever coating dispenser technology or technologies are used, implementing separate spraying zones for different coating processes increases the overall resources required to implement the coating processes relative to implementing a coating process within a single, compact booth.

### SUMMARY

A system and method is disclosed including a coating booth and coating dispensing robots. The robots are mounted relative to the booth such that the robots' coating dispensers are operably disposed within the booth. The robots are in communication with at least one controller, which include computer readable instructions written on a computer memory that upon execution move one of the robots and dispenses coating on one or more of at least a portion of an engine compartment, trunk and internal surfaces of a bed of an automotive workpiece during a first time interval. The controller also moves the second robot over a second set of coordinates and causes the robot to dispense coating on one or more of at least a portion of an exterior surface of fenders and passenger doors of the workpiece over the first time interval.

The controller also moves the first robot over a third set of coordinates and causes the first robot to dispense coating on one or more of at least a portion of an exterior surface of a hood, roof, trunk lid and lift gate over a second time interval. The controller also moves the second robot over a fourth set of coordinates and causes the robot to dispense coating on one or more of at least a portion of the side door interiors over the second time interval.

### BRIEF DESCRIPTION OF THE DRAWINGS

In the accompanying drawings, structures and methods are illustrated that, together with the detailed description provided below, describe aspects of a system and method for interlaced coating application. It will be noted that a single component may be designed as multiple components or that multiple components may be designed as a single component.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1 illustrates a plan view of a coating system 100.

FIG. 2 illustrates a sectional side view of workpiece 110 along the line 2-2 shown in FIG. 1.

FIG. 3 illustrates a sectional rear view of coating system 100 along the line 3-3 shown in FIG. 1.

FIG. 4 illustrates a plan view of a coating system 400.

FIG. 5 illustrates a sectional side view along the line 5-5 shown in FIG. 4.

FIG. 6 illustrates a diagrammatic view of a controller 136a.

FIG. 7 illustrates steps of a method 700 of coating an automotive workpiece.

FIG. 8 illustrates steps of a method 800 of coating an automotive workpiece.

### DETAILED DESCRIPTION

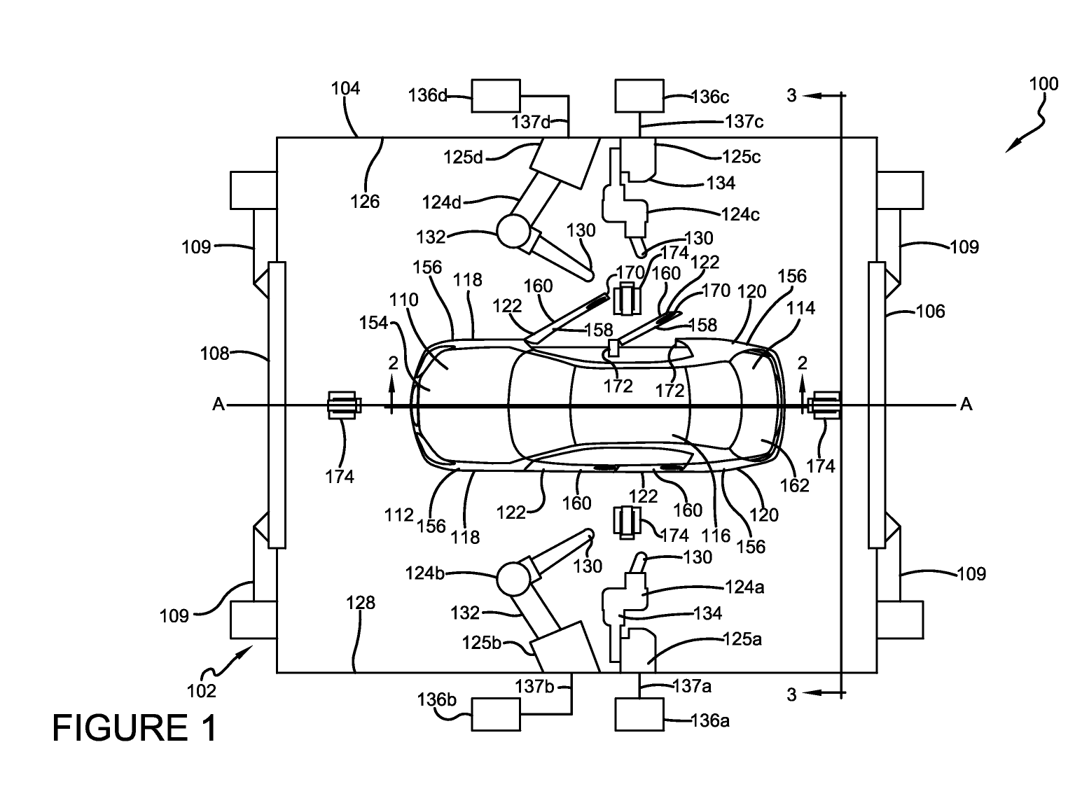

FIG. 1 illustrates a coating system 100 according to the present teachings. The system 100 includes a spray booth 102 having an entry door 106 and exit door 108 that can open and close by operation of actuators 109 to allow a workpiece 110, which in the illustrated case is a partially assembled passenger automobile, to enter and exit the housing 104. The illustrated partially assembled automobile includes an engine hood 112, trunk lid 114, roof 116, front fenders 118, rear fenders 120 and passenger doors 122. A fully assembled automobile can also function as a workpiece according to the present teachings. The workpiece 110 can be moved into the housing 104 through the use of a conveyor, or if the workpiece is an assembled automobile in operating condition it can be driven or manually rolled into the housing 104. While the coating system 100 disclosed herein is well suited to applying coatings to a workpiece 110 that is a land vehicle, such as an automobile or truck, it should be appreciated that the present teachings may be used to apply coatings to other workpieces 110, such as airplanes and boats. Coatings that can be applied according to the teachings herein include but are not limited to primers, clear coats and basecoats including color coats.

The illustrated booth 102 has sufficient size to accept a single stationary workpiece 110. A booth having the minimum size sufficient to fit a single workpiece 110 minimizes the volume of air that must be moved through the booth per unit time to maintain optimum coating application conditions. Minimizing the size of the booth 102 can save resources such as energy spent heating and moving air through the booth 102 and the physical space required for installation of the booth 102, for example. However, such larger booths can also be implemented according to the present teachings, for example by having sufficient space to fit multiple workpieces, with or without additional coating dispensing robots 124 arranged similarly to those shown and described herein. According to one aspect of the present teachings, the housing is about 8 meters in length. According to yet other aspects, the housing length can range between about 6 and 10 meters in length. A booth having sufficient size to accept a single non-stationary workpiece 110 can also be implemented according to the present teachings. For example, by moving the workpiece 110 through the booth 102 during the coating process, coating can be applied within a window narrower than the length of the workpiece and still achieve complete coverage of the workpiece 110. For example, coating can be applied within a range of 3 to 4 meters, whereas the workpiece 110 can have a length greater than that range, for example 5 meters.

Coating dispensing robots 124a-d have bases 125a-d mounted adjacent to a right side wall 126 and left side wall 128 of the booth 102, respectively. The left and right sides of the booth 102 are separated by a central plane A extending along the length of the booth 102 from the entry door 106 and exit door 108 and vertically upward in a direction perpendicular to the floor of the booth 102. The central plane A is about equidistant from the side walls 126, 128 of the booth 102 and aligns with the central axis of the workpiece 110. The projection of central plane A on the floor of the booth 102 also defines a travel path of the workpiece 110 through the booth 102.

The robots 124a-d can be mounted in locations other than those illustrated. For example, one or more of the robots 124a-d can be mounted on the ceiling of the booth 102 or on tracks such that the robots 124a-d are moveable. According to one aspect of the present teachings, the coating dispensing robots 124a-d are equipped with coating dispensers 130 that are electrostatic rotational bell-type sprayers. According to another aspect of the present teachings, each of the coating dispensing robots 124a-d is equipped with the same type of coating dispensers 130, whether rotational bell-type sprayers, or other forms of sprayers. The robots 124a-d move the dispensers 130 within the booth 102 relative to the workpiece and can simultaneously apply coating to the workpiece 110 with the dispensers 130. The dispensers 130 are not limited to movement on the same side of the booth 102 on which their respective robots 124a-d are mounted, but rather can move across the central plane A to reach portions of the workpiece 110 on the side of A opposite to side on which their respective robots 124a-d are mounted. According to yet another aspect of the present teachings, a set of robots 124 mounted on one of the side walls 126, 128 may be implemented, for example where the vehicle size is small enough such that only a single pair of robots 124 is necessary, or where the vehicle is rotated such that opposing sides are coating in turn by a single pair of robots 124.

The robots 124a-d are each connected to a controller 136a-d via connection 137a-d, such as cabling capable of providing control signals and power to the robots 124a-d. The controllers 136a-d can include, for example, a central processing unit that executes computer-readable instructions stored on memory and a power supply for the individual robots and their corresponding dispensers 130. According to other aspects of the present teachings, the four illustrated robots 124a-d can be connected to a single controller that provides the functionality of the four individual controllers 136a-d illustrated in FIGS. 1, 3 and 4. According to other aspects of the present teachings, one or more controllers 136a-d can be implemented with the coating dispensing robots 124a-d. In one example, one controller can be connected to two or more dispensing robots 124. For example, as single controller can control each of the dispensing robots 124a-d shown in FIGS. 1, 3 and 4. According to yet other aspects of the present teachings, redundant controllers can be connected to one or more of the dispensing robots 124a-d.

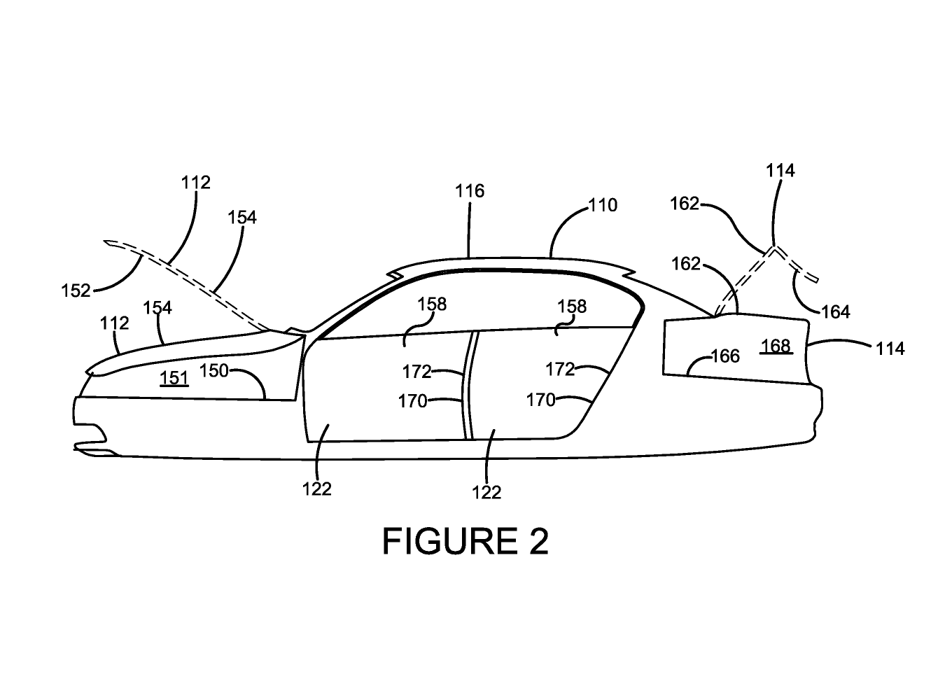

FIG. 2 illustrates a sectional side view of workpiece 110 along the line 2-2 in FIG. 1. Several surfaces of the workpiece 110 that are shown in FIGS. 1 and 2 can be coated according to the teachings herein, including the internal surface 150 of the engine compartment 151, the underside 152 of the engine hood 112, the exterior surface 154 of the engine hood 112, the exterior surfaces 156 of the front fenders 118 and rear fenders 120, the interior surfaces 158, exterior surfaces 160 and frame interfacing surfaces 170 of the passenger doors 122, the roof 116, the exterior surface 162 of the trunk lid 114, the underside 164 of the trunk lid 114, the internal surface 166 of the trunk 168 and the door interfacing surface of the frame 172.

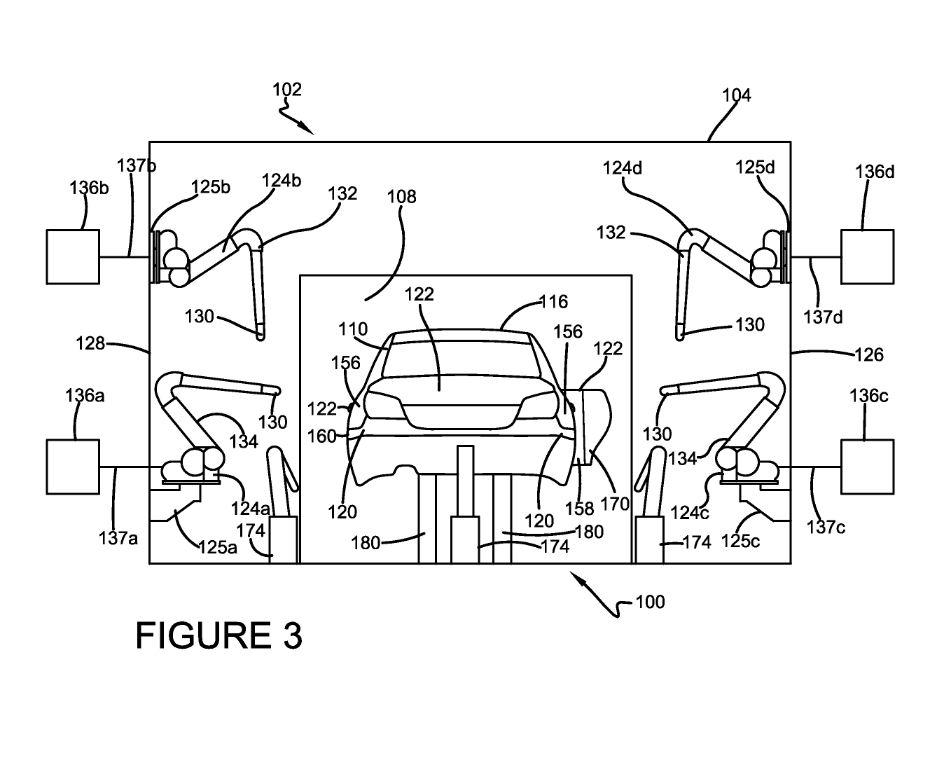

As shown in FIG. 3, the coating dispensing robots 124 are spaced apart vertically such that one is disposed at a greater height than the other on a particular wall. The upper dispensing robots 132 are mounted to a side wall of the booth 102 at a position above the lower dispensing robots 134, which are also mounted to the walls of the booth. Such a mounting arrangement wherein one coating dispensing robot 124 is positioned over the other allows for simultaneous, non-interfering access to the workpiece 110 by the coating dispensing robots 124a-d. Workpiece mounts 180 hold the workpiece during the coating process, and can be placed on tracks to move the workpiece 110 into and out of the housing 104. In yet other aspects of the present teachings, the dispensing robots 124 can be mounted in a variety of positions, such as mounting one or both robots on fixed points on the floor or mounting the robots 124 on the ceiling or shelf In yet another aspect of the present teachings, the robots 124 can be moveably mounted within the booth 102, for example on tracks allowing the robots 124 to move during the spraying process.

Opening and closing robots 174 are placed around the booth 102, allowing access of at least one of the robots 174 to the engine hood 112, passenger doors 122 and trunk lid 114. The opening and closing robots 174 open and close the engine hood 112, passenger doors 122 and trunk lid 114 at appropriate times during the application of coating on the workpiece 110. The opening and closing robots 174 can be controlled by dedicated controllers that can be put into communication with controllers 136 to synchronize the actions of the opening and closing robots 174 with the coating dispensing robots 124.

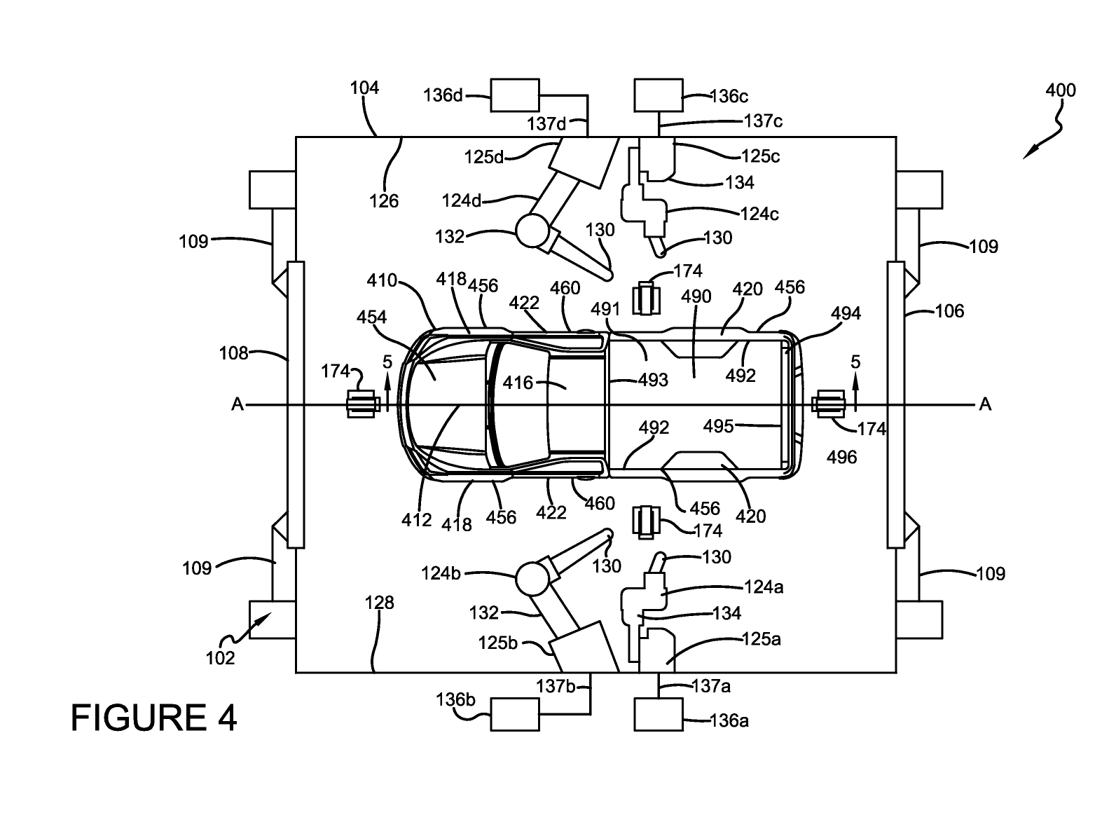

With reference to FIG. 4, a workpiece 410 in the form of a partially assembled pickup truck is disposed within the booth 102. Similarly to the passenger automobile workpiece 110, the workpiece 410 includes an engine hood 412, roof 416, front fenders 418, rear fenders 420 and passenger doors 422. The workpiece 410 also includes a truck bed 490. The bed 490 includes a floor 491, side walls 492, rear wall 493 and a lift gate 494 having an interior surface 495 and exterior surface 496.

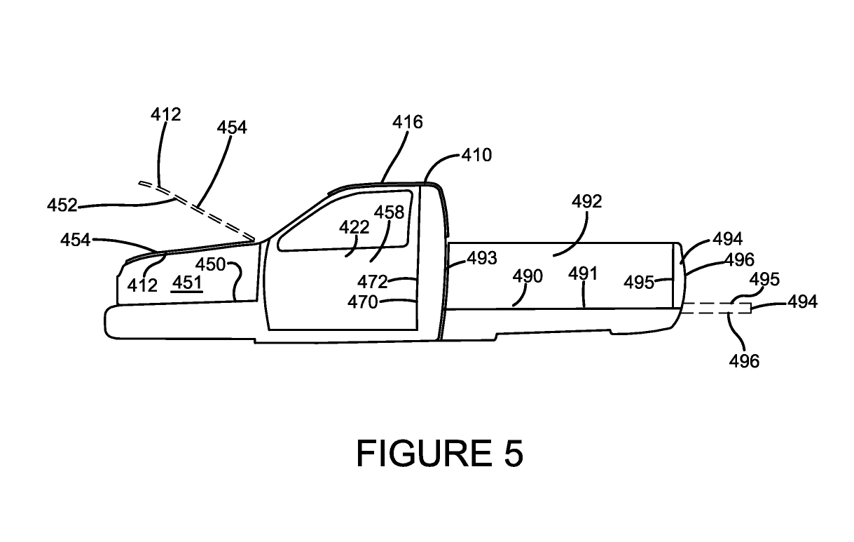

FIG. 5 illustrates a sectional side view of workpiece 410 along the line 5-5 in FIG. 4. Several surfaces of the workpiece 410 that are shown in FIGS. 4 and 5 can be coated according to the teachings herein, including the internal surface 450 of the engine compartment 451, the underside 452 of the engine hood 412, the exterior surface 454 of the engine hood 412, the exterior surfaces 456 of the front fenders 418 and rear fenders 420, the interior surfaces 458, exterior surfaces 460 and frame interfacing surfaces 470 of the passenger doors 422, the door interfacing surface of the frame 472, the roof 416, the floor 491, side walls 492, rear wall 493, and interior 495 and exterior surface 496 of the lift gate 494.

As used herein, the term “internal surfaces” denotes surfaces of a workpiece that are typically not directly exposed to the external environment. However, a bed of a truck is also typically considered to be comprised of internal surfaces. Examples of such internal surfaces are the internal surface 150 of the engine compartment 151, the underside 152 of the engine hood 112, the underside 164 of the trunk lid 114 and the internal surface 166 of the trunk 168, the interior surfaces 158 and frame interfacing surfaces 170 of the passenger doors 122 facing the passenger compartment, the internal surface 166 of the trunk 168 and the door interfacing surface of the frame 172 shown in connection with workpiece 110 shown in FIGS. 1-3. Several of these features are also present in the workpiece 410 shown in FIGS. 4 and 5. Other features present in the truck workpiece 410 that are internal surfaces include the floor 491, side walls 492, rear wall 493, interior surface 495 of the lift gate 494, and the door interfacing surface of the frame 472.

As used herein, the term “external surfaces” denotes those surfaces that face the external environment, such as the exterior surface 156 of the front fenders 118 and rear fenders 120, the external surfaces 160 of the passenger doors 122, the external surface 162 of the trunk lid 114, external surface 154 of the engine hood 112 and the roof 116. Several of these features are also present in the workpiece 410 shown in FIGS. 4 and 5. Other features present in the truck workpiece 410 that are external surfaces are the external surface 496 of the lift gate 494.

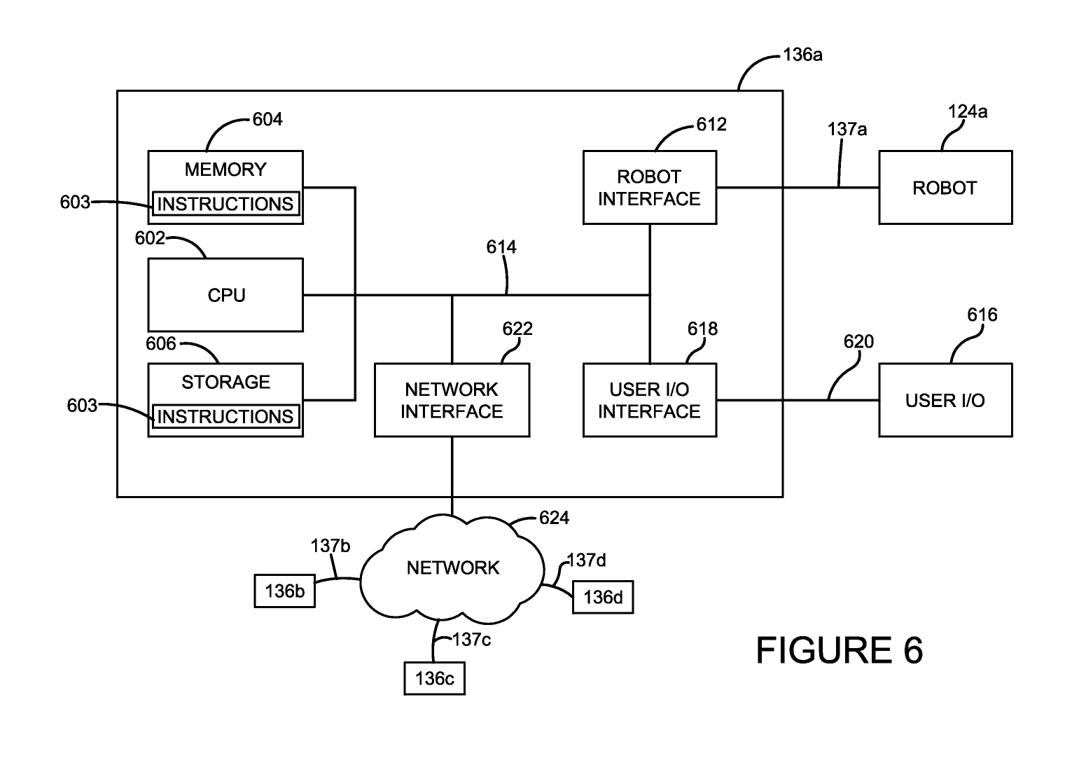

With reference to FIG. 6 the controller 136a that is utilized to control the robots 124a though connection 137a includes a central processing unit (“CPU”) 602, computer memory such as random access memory (“RAM”) 604 and storage 606 that can include one or more hard drives. The CPU 602 executes instructions 603 stored on one or both of the RAM 604 and storage 606. The instructions 603 written on one or both of the RAM 604 and storage 606 are written in a suitable computer-readable programming language such as the C programming language, or a programming language written for use with robots, such as the RAPID programming code made available by ABB, Inc.

The controller 136a is connected to robot 124a through electrical connection 137a, such as one or more cables. A robot interface 612 manages communication between the robot 124a and controller 136a, transmitting electrical signals and optionally operating power to the robot. According to one aspect of the present teachings, upon execution of the instructions 603 stored on at least one of the RAM 604 or storage 606 by the CPU 602, the CPU 602 provides signals to the robot interface 612 through the bus 614 that cause to the robot interface 612 to communicate signals to the robot 124a though connection 137a. The signals provided by robot interface 612 in turn cause the robot 124a to move and dispense coating as directed by the CPU 602. The robot interface 612 can, for example, cause the robot 124a to move to a particular position or move with a particular velocity. According to one aspect of the present teachings, the controller 136a can cause the robot 124a having a coating dispenser 130 to undertake motion wherein the robot 124a follows a particular path with a predefined velocity and with the coating dispenser 130 oriented toward the workpiece 110 in a direction defined by a set of coordinates corresponding to the degrees of freedom of the robot 124a. The path thus includes information about each of the degrees of freedom of the robot 124a. Where the robots each have six degrees of freedom, the path taken by the robot 124a and dispenser 130 can be represented by Φₖ, where k=1 to 6, accounting for the 6 degrees of freedom. It should be noted that robots having less than or more than six degrees of freedom is possible. Additional degrees of freedom, such as 7, 8, 9 or more, are possible by, for example, including additional joints to the robot. Less degrees of freedom may compromise the flexibility afforded by robots having 6 degrees of freedom. For example, having 5 or 4 degrees of freedom can be implemented where 6 degrees of freedom are not requires due to, for example, the shape of the workpiece not requiring movement of the dispenser while coating the workpiece.

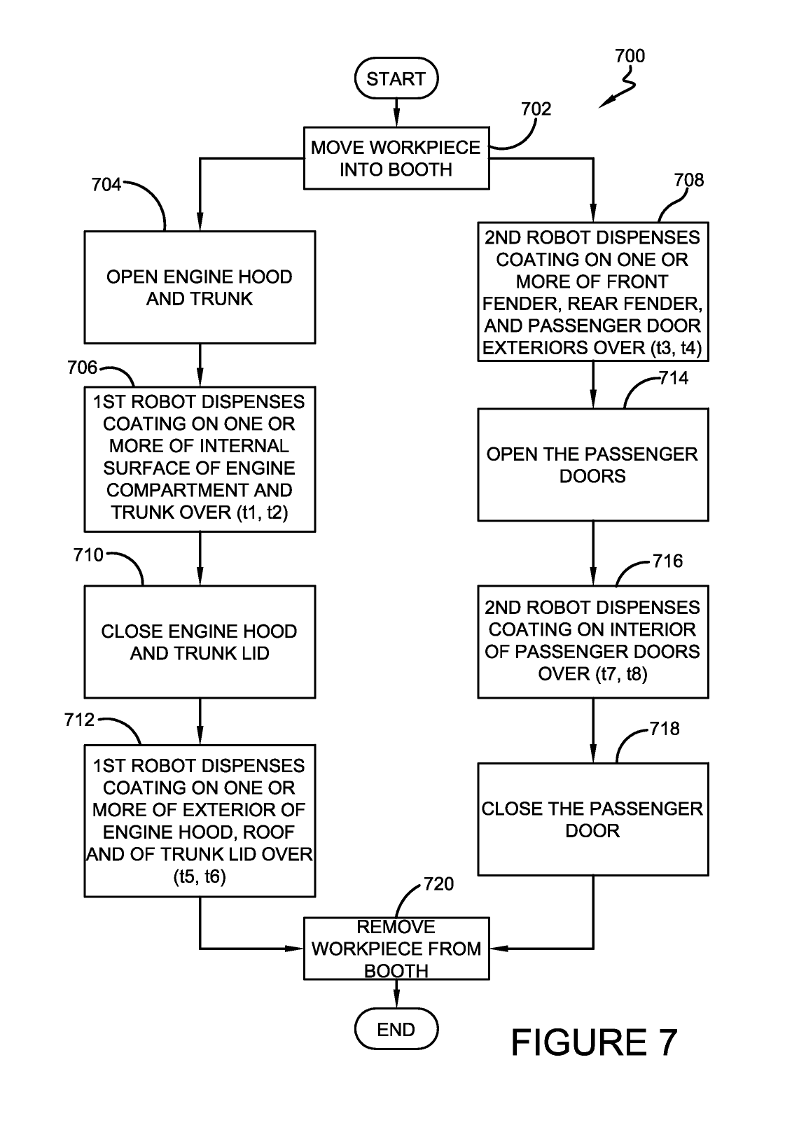

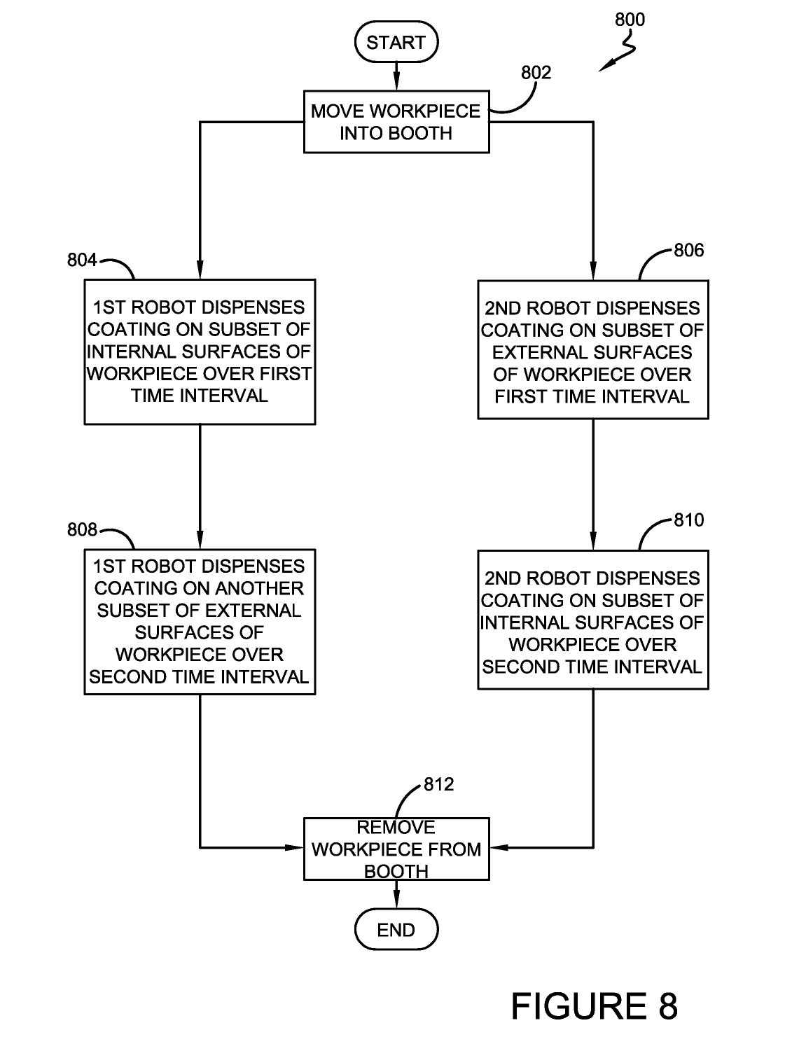

A user input/output (I/O) 616 such as a keyboard or remote control can be used to input instructions 603 into controller 136a. The user I/O 616 communicates with the user I/O interface 618 through connection 620. The user I/O 616 can be used to input instructions 603 into the controller 136a. According to one aspect of the present teachings, the user I/O 616 can be used to input a travel path, which can be defined by the coordinates Φₖ, where k=1 to 6 accounting for the 6 degrees of freedom, that will be followed by the robots 124a-d during the coating process, a speed and coating flow rate along the path Φₖ, k=1 to 6, and storing the path, speed and flow rate to at least one of the RAM 604 or storage 606. According to another aspect of the present teachings, the RAM 604 or storage 606 can have instruction 603 written upon them to execute coating processes described herein with regard to FIGS. 7 and 8.

A network interface 622 permits connection between controller 136a and a network 624. Additional controllers 136b-d are also connected to the network 624 though connections 137b-d allowing the controllers 136a-d to be in communication and further allowing the controllers 136a-d to synchronize their actions during application of coating on a workpiece such as workpieces 110 or 410. It should be noted that the aspects of controllers 136 described herein can be distributed, such as by providing computing resources and memory through a computer workstation, and providing the robot interface within a separate unit that communicates with the workstation through a communication linkage such as a wireless connection or suitable cabling.

FIG. 7 illustrates a method 700 for coating a workpiece 110 according to one aspect of the present teachings performed, for example, by coating system 100, including robots 124a-d operated by controllers 136a-d and having dispensers 130 such as electrostatic rotational bell-type sprayers. In step 702, the workpiece 110 is moved into the spray booth 102. In step 704, one or both of the trunk lid and engine hood of a workpiece 110 are opened, for example by action of opening and closing robots 174, to allow access to one or both of the engine compartment and trunk of the workpiece 110. In step 706 a first robot 124a moves along a first path, which can be defined by the coordinates Φₖ(t), k=1 to 6, corresponding to the robot's degrees of freedom, over a timespan denoted t=(t1, t2), which notation denotes the time between t1 and t2 where t2 is greater than t1. Over the timespan (t1, t2), the first robot 124a dispenses coating, such as automotive primers, color coats and clear coats, on internal surfaces of the engine compartment and trunk.

In step 708, a second robot 124b moves a second coating dispenser along a second path over a timespan denoted t=(t3, t4), during which time the second robot 124b dispenses a selected coating on one or more of the external surfaces of the front fenders, rear fenders and external surfaces of the passenger doors. According to one aspect of the present teachings, the timespans (t1, t2) and (t3, t4) both occur during a first time interval, which starts prior to the earliest of t1 and t3, and ends after the latest of t2 and t4. According to another aspect of the present teachings, at least half of at least one of the timespans (t1, t2) and (t3, t4) overlap with the other of the two. For example, in arbitrary units of time, where t1=1, t2=4, t3=3 and t4=5, fifty percent of the timespan (t3, t4) overlaps with timespan (t1, t2). According to another aspect of the present teachings, at least 75 percent of at least one of the timespans (t1, t2) and (t3, t4) overlap with the other timespan. According to yet another aspect of the present teachings, t1=t3 and t2=t4, so that timespans (t1, t2) and (t3, t4) are the same. The timespans (t1, t2) and (t3, t4) can be coextensive with the first time interval, but need not be.

In step 710, the engine hood and trunk lid are closed by operation of opening and closing robot such as opening and closing robots 174 shown in FIGS. 1 and 3. In step 712, the first robot 124a moves its coating dispenser along a third path over a timespan denoted t=(t5, t6), during which the first robot 124a dispenses coating on the exterior surfaces of the hood, roof and trunk lid.

In step 714, the passenger doors are opened by operation of opening and closing robot 174. In step 716, the second robot 124b moves its coating dispenser along a fourth path over a fourth timespan denoted t=(t7, t8), during which time the second robot 124b dispenses coating on one or more of the interior surfaces of the front and rear passenger doors. In step 718, the passenger doors are closed by operation of opening and closing robot 174. According to one aspect of the present teachings, the timespans (t5, t6) and (t7, t8) overlap at least partially. According to one aspect of the present teachings, the timespans (t5, t6) and (t7, t8) both occur during a second time interval, which starts prior to the earliest of t5 and t7, and ends after the latest of t6 and t8. According to another aspect of the present teachings, at least half of at least one of the timespans (t5, t6) and (t7, t8) overlap with the other timeframe. According to yet another aspect of the present teachings, at least 75 percent of at least one of the timespans (t5, t6) and (t7, t8) overlap with the other timespan. According to yet another aspect of the present teachings, t5=t7 and t6=t8, so that timespans (t5, t6) and (t7, t8) are the same. The timespans (t5, t6) and (t7, t8) can be coextensive with the second time interval, but need not be. According to a further aspect of the present teachings, the second time interval can start after the first time interval ends.

According to yet other aspects of the present teachings, the order of the coating processes performed during the first and second time intervals can be ordered differently within the first and second time intervals. For example, the ordering of which surfaces are coated can be such that the interiors of the engine compartments and trunk can be coated prior to, during or after the front fender, rear fender and passenger door exterior are coated. As another example, the exterior of the engine hood, roof and trunk lid can be coated prior to, during or after the interiors of the passenger doors. Further, the second time interval and corresponding coating processes described herein as occurring during the second time interval can occur prior to the first time interval and corresponding coating processes. In step 720, the workpiece 110 is removed from the spray booth 102.

FIG. 8 illustrates another method 800 for coating a workpiece 110 according to the present teachings with robots 124 having coating dispensers 130 such as air-powered electrostatic rotational bell-type sprayers. In step 802 the workpiece 110 is moved into the spray booth 102. In step 804, a first robot 124a dispenses a selected coating on a subset of the internal surfaces of the workpiece 110 over a first time interval. In step 806, a second robot 124b dispenses a selected coating on a subset of the external surfaces of the workpiece 110 over the first time interval. In step 808, the first robot 124a dispenses a selected coating on another subset of the external surfaces of the workpiece 110, different from the external surfaces coated by the second robot 124b during a second time interval. In step 810, the second robot 124b dispenses a selected coating on another subset of the internal surfaces different from the subset of the internal surfaces coated by the first robot 124a over the second time interval. Overlap between the subsets of the external surfaces coated during the first and second time intervals, and between the subsets of the internal surfaces coated during the first and second time intervals are permissible, in particular at the edges of the surface subsets. The amount of permissible overlap will depend on the characteristics of the coating such as drying time and also the allowed tolerance in the thickness of the coating. In step 812, the workpiece is removed from the booth.

In another aspect of the present teachings, third and fourth coating robots can be mounted within the spray booth that can, for example, follow mirror image paths to the first and second robots, respectively, described in connection with FIGS. 7 and 8. In this way, the burden of coating the sides of the workpiece on one side or the other of the axis of symmetry of the workpiece can be shared between the robots.

For the purposes of this disclosure and unless otherwise specified, “a” or “an” means “one or more.” To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term. From about A to B is intended to mean from about A to about B, where A and B are the specified values.

While the present disclosure illustrates various embodiments, and while these embodiments have been described in some detail, it is not the intention of the applicant to restrict or in any way limit the scope of the claimed invention to such detail. Additional advantages and modifications will be apparent to those skilled in the art. Therefore, the invention, in its broader aspects, is not limited to the specific details and illustrative examples shown and described. Accordingly, departures may be made from such details without departing from the spirit or scope of the applicant's claimed invention. Moreover, the foregoing embodiments are illustrative, and no single feature or element is essential to all possible combinations that may be claimed in this or a later application.

1. An automotive coating system comprising:
a coating booth;
first and second coating dispensing robots each having coating dispensers and mounted relative to the booth such that the dispensers are operably disposed within the booth;
each of the first and second robots in communication with at least one controller, the at least one controller including computer readable instructions written on a memory that upon execution:
move the first robot over a first set of coordinates and dispense coating on one or more of an engine compartment, a trunk and internal surfaces of a bed of a workpiece during a first time interval with the first robot;
move the second robot over a second set of coordinates and dispense coating on one or more of exterior surfaces of fenders and passenger doors of the workpiece over the first time interval with the second robot;
move the first robot over a third set of coordinates and dispense coating on one or more of exterior surfaces of a hood, roof, trunk lid and lift gate over a second time interval with the first robot; and,
move the second robot over a fourth set of coordinates and dispense coating on one or more of a side door interiors over a second time interval with the second robot.

2. The system of claim 1, further comprising,
a housing having a selectively openable entry door at a first end of the coating booth, a selectively openable exit door at a second end of the coating booth, a first and second side wall extending from the first end to the second end; and,
a third and fourth robot each having coating dispensers and mounted relative to the booth such that the dispensers are operably disposed within the booth.

3. The system of claim 2, wherein the distance from the entry door to the exit door along a centrally disposed longitudinal axis extending from the first end to the second end is about 5 meters.

4. The system of claim 2, wherein a base of the first robot is mounted above a base of the second robot on one side of a centrally disposed longitudinal axis extending from the first end to the second end, a base of the third robot is mounted above a base of the fourth robot on a second side of the centrally disposed longitudinal axis opposite the first side.

5. The system of claim 2, wherein the third and fourth robots are in communication with the at least one controller, the at least one controller including computer readable instructions written on a memory that upon execution:
move the third robot over a fifth set of coordinates and dispense coating on one or more of at least a portion of the engine compartment, trunk and internal surfaces of the bed of the workpiece with the third robot over the first time interval;
move the fourth robot over a sixth set of coordinates and dispense coating on one or more of at least a portion of the exterior surface of the fenders and passenger doors of the workpiece with the fourth robot over the first time interval;
move the third robot over a seventh set of coordinates and dispense coating on one or more of at least a portion of the exterior surface of the hood, roof, trunk lid and lift gate with the third robot over the second time interval; and,
move the fourth robot over a eighth set of coordinates and dispense coating on one or more of at least a portion of the side door interiors with the fourth robot over the second time interval.

6. The system of claim 1, wherein the booth is sized to permit only a single workpiece to fit within the booth during the first and second time intervals.

7. The system of claim 1, wherein the second time interval starts after the first time interval ends.

8. An automotive coating system comprising:
a booth;
first and second coating dispensing robots each having coating dispensers operably disposed within the booth and in communication with at least one controller configured to accept computer readable instructions on a memory that upon execution:
dispense coating on a first subset of internal surfaces of an automotive workpiece with the dispenser of the first robot during a first time interval;
dispense coating on a first subset of external surfaces of the automotive workpiece with the dispenser of the second robot during the first time interval;
dispense coating on a second subset of external surfaces of the automotive workpiece with the dispenser of the first robot over a second time interval; and,
dispense coating on a second subset of internal surfaces of the automotive workpiece with the dispenser of the second robot over the second time interval.

9. The system of claim 8, further comprising,
a selectively openable entry door at a first end of the coating booth;
a selectively openable exit door at a second end of the coating booth;
a first and second side wall extending from the first end to the second end of the coating booth; and,
a third and fourth robot each having coating dispenser operably disposed within the booth.

10. The system of claim 9, wherein the distance from the entry door to the exit door along a travel path of the workpiece is about 5 meters.

11. The system of claim 9, wherein a base of the first robot is mounted to the booth above a base of the second robot on one side of a travel path of a workpiece, a base of the third robot is mounted to the booth above a base of the fourth robot on a second side of the travel path of the workpiece opposite the first side.

12. The system of claim 9, wherein the at least one controller is in communication with the third and fourth robots and configured to accept computer readable instructions on a memory that upon execution:
dispense coating on a third subset of internal surfaces of an automotive workpiece with the dispenser of the third robot during the first time interval;
dispense coating on a third subset of external surfaces of the automotive workpiece with the dispenser of the fourth robot during the first time interval;
dispense coating on a fourth subset of external surfaces of the automotive workpiece with the dispenser of the third robot over the second time interval; and,
dispense coating on a fourth subset of internal surfaces of the automotive workpiece with the dispenser of the fourth robot over the second time interval.

13. The system of claim 8, wherein the booth is sized to permit only a single workpiece to fit within the booth during the first and second time intervals.

14. The system of claim 8, wherein the second time interval starts after the first time interval ends.

15. A method of coating a workpiece, comprising:
providing an automotive workpiece in a coating application booth;
dispensing coating on a first subset of internal surfaces of an automotive workpiece with a dispenser of a first robot during a first time interval;
dispensing coating on a first subset of external surfaces of the automotive workpiece with a dispenser of a second robot during the first time interval;
dispensing coating on a second subset of external surfaces of the automotive workpiece with the dispenser of the first robot over a second time interval; and, dispensing coating on a second subset of internal surfaces of the automotive workpiece with the dispenser of the second robot over the second time interval.

16. The method of claim 15, wherein the step of dispensing coating on a first subset of internal surfaces of an automotive workpiece includes dispensing coating on one or more of at least a portion of an engine compartment, trunk and internal surfaces of a bed of the workpiece with the first robot, the step of dispensing coating on a first subset of external surfaces of the automotive workpiece includes dispensing coating on one or more of at least a portion of an exterior surface of fenders and passenger doors of the workpiece with the second robot, the step of dispensing coating on a second subset of external surfaces of the automotive workpiece includes dispensing coating on at least a portion of one or more of an exterior surface of a hood, roof, trunk lid and lift gate with the first robot and the step of dispensing coating on a second subset of internal surfaces of the automotive workpiece includes dispensing coating on at least a portion of one or more of a side door interiors with the second robot.

17. The method of claim 16, further comprising:
dispensing coating on one or more of at least a portion of the engine compartment, trunk and internal surfaces of a bed of the workpiece during the first time interval with a third robot;
dispensing coating on one or more of at least a portion of the exterior surface of the fenders and passenger doors of the workpiece during the first time interval with a fourth robot;
dispensing coating on one or more of at least a portion of the exterior surface of the hood, roof, trunk lid and lift gate over a second time interval with the third robot; and,
dispensing coating on one or more of at least a portion of the side door interiors over the second time interval with the fourth robot.

18. The method of claim 15, further comprising:
dispensing coating on a third subset of internal surfaces of the automotive workpiece with a dispenser of the third robot during the first time interval;
dispensing coating on a third subset of external surfaces of the automotive workpiece with a dispenser of the fourth robot during the first time interval;
dispensing coating on a fourth subset of external surfaces of the automotive workpiece with the dispenser of the third robot over the second time interval; and,
dispensing coating on a fourth subset of internal surfaces of the automotive workpiece with the dispenser of the fourth robot over the second time interval.

19. The method of claim 15, wherein the second time interval starts after the first time interval ends.

20. The method of claim 15, further comprising:
opening an entry door of the booth prior to the step of providing the workpiece;
closing the entry door prior to the first and second time intervals;
opening the exit door after the first and second time intervals; and,
removing the workpiece after the step of opening the exit door.
